(19) United States
(12) Patent Application Publication
(10) Pub. No.: US 2026/0307710 A1
(43) Pub. Date: Oct. 8, 2026

(54) SYSTEMS AND METHODS FOR AN OPTIMIZED STEER-BY-WIRE ARCHITECTURE WITH LIMITED FEEDBACK CONTENT

(71) Applicant: STEERING SOLUTIONS IP HOLDING CORPORATION, Saginaw, MI (US)

(72) Inventors: Björn KASPAR, Mainz (DE); Michael A. EICKHOLT, Chesaning, MI (US); Ahmed DAGHSEN, Villetaneuse (FR); Marcin BALION, Sosnowiec (PL); Mateusz J. OSTAFIN, Rogoznik (PL); Marcin ZAPLOTNY, Rudziczka (PL); Jonas PROSS, Bensheim (DE); Lukasz STACHOWIAK, Tychy (PL)

(21) Appl. No.: 19/638,481

(22) Filed: Apr. 3, 2026

Related U.S. Application Data
(60) Provisional application No. 63/783,308, filed on Apr. 4, 2025.

(51) Int. Cl. B62D 5/00

(52) U.S. Cl. CPC B62D 5/003; B62D 5/006

(57) ABSTRACT

A vehicle steering control method includes: generating, using a first electronic control unit, a feedback torque in response to a steering input; supplying power, using a first power supply, to the first electronic control unit; controlling, using a second electronic control unit, at least one vehicle wheel based on the feedback torque and the steering input; supplying power, using a second power supply, to the second electronic control unit; determining whether the second power supply has failed; and in response to a determination that the second power supply has failed, instructing the first electronic control unit to communicate the steering input and the feedback torque to the second electronic control unit, wherein the second electronic control unit receives power from the first power supply in response to the determination that the second power supply has failed.

### CROSS-REFERENCE TO RELATED APPLICATIONS

The present disclosure claims priority to US Provisional Patent Application Serial No. 63/783,308, filed Apr. 4, 2025, which is incorporated herein by reference in its entirety.

### TECHNICAL FIELD

This disclosure relates to steering systems, and in particular, to systems and methods for an optimized steer-by-wire architecture with limited feedback content.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a system for controlling vehicle steering. The system includes: a first electronic control unit configured to generate a feedback torque, using a feedback torque mechanism, in response to a steering input; a first power supply configured to supply power to the first electronic control unit; a second electronic control unit configured to control at least one vehicle wheel based on the feedback torque and the steering input; a second power supply configured to supply power to the second electronic control unit; and a controller configured to: determine whether the second power supply has failed; and in response to a determination that the second power supply has failed, instruct the first electronic control unit to communicate the steering input and the feedback torque to the second electronic control unit, wherein the second electronic control unit receives power from the first power supply in response to the determination that the second power supply has failed.

Another aspect of the disclosed embodiments includes a method for controlling vehicle steering. The method includes: generating, using a first electronic control unit, a feedback torque, using a feedback torque mechanism, in response to a steering input; supplying power, using a first power supply, to the first electronic control unit; controlling, using a second electronic control unit, at least one vehicle wheel based on the feedback torque and the steering input; supplying power, using a second power supply, to the second electronic control unit; determining whether the second power supply has failed; and in response to a determination that the second power supply has failed, instructing the first electronic control unit to communicate the steering input and the feedback torque to the second electronic control unit, wherein the second electronic control unit receives power from the first power supply in response to the determination that the second power supply has failed.

Another aspect of the disclosed embodiments includes an apparatus for controlling vehicle steering. The apparatus includes a processor and a memory. The memory includes instructions that, when executed by the processor, cause the processor to: generate, using a first electronic control unit, a feedback torque, using a feedback torque mechanism, in response to a steering input; supply power, using a first power supply, to the first electronic control unit; control, using a second electronic control unit, at least one vehicle wheel based on the feedback torque and the steering input; supply power, using a second power supply, to the second electronic control unit; determine whether the second power supply has failed; and in response to a determination that one of the first power supply and the second power supply has failed, instruct the first electronic control unit to communicate the steering input and the feedback torque to the second electronic control unit, wherein the second electronic control unit receives power from the first power supply in response to the determination that the second power supply has failed.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIG. 3 is an optimized steer-by-wire architecture with limited feedback content, according to the principles of the present disclosure.

FIG. 4 is a flow diagram generally illustrating a vehicle steering control method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an EPS system, an SbW steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

A traditional SbW steering system typically consists of an interface to the driver that measures drivers' position, an interface that provides feedback to the driver, and an interface with the wheels of the vehicle. An SbW steering system can also provide interface to a virtual driver for autonomous and advance driver safety features.

When the driver is engaged with the SbW steering system, typically, a plurality of methods are used to determine the driver intention. Knowing driver’s intent may be used to determine the amount of motion needed at the interface with the wheels of the vehicle. There are many ways to measure driver intention beyond measuring the steering wheel motion directly. However, these methods typically have some level of independence from common failures. Rather than creating methods both physically and electrically independent for measuring the driver intent, it is possible to provide a level of dependency while maintaining protection from common failures.

Accordingly, systems and methods, such as those described herein, configured to allow for driver control of SbW steering system, while optimizing for component count, may be desirable. In some embodiments the systems and methods described herein may be configured to provide a minimalist mechanical and electrical architecture that allows for driver control of the SbW steering system after occurrence of single or multiple faults, where the SbW steering system has dependencies between feedback and driver intentions.

The systems and methods described herein may be configured to, in an SbW steering system, maintain for controllability at least two functions: (i) knowing the driver’s intent; and (ii) actuating the steering wheels. The systems and methods described herein may be configured to provide redundancy to the two functions.

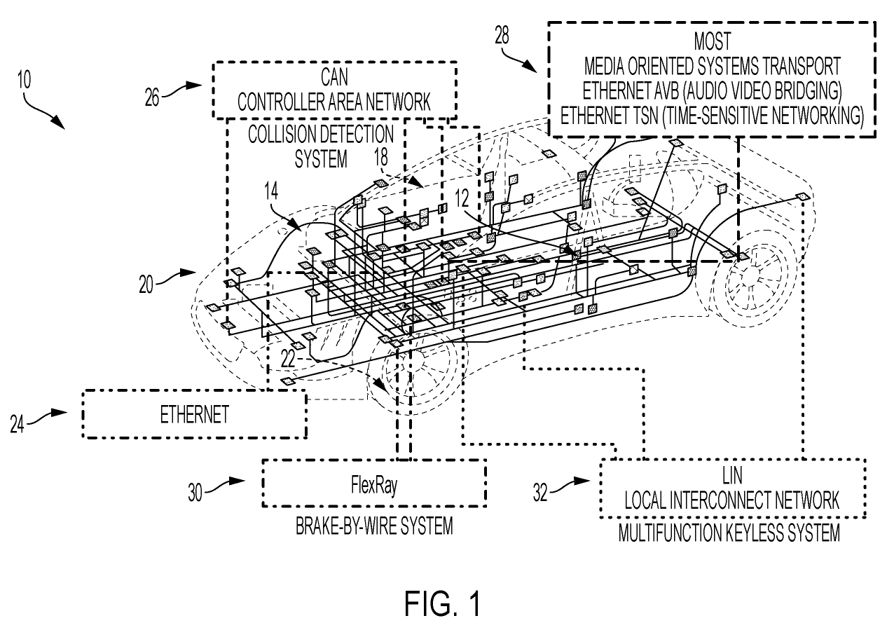

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

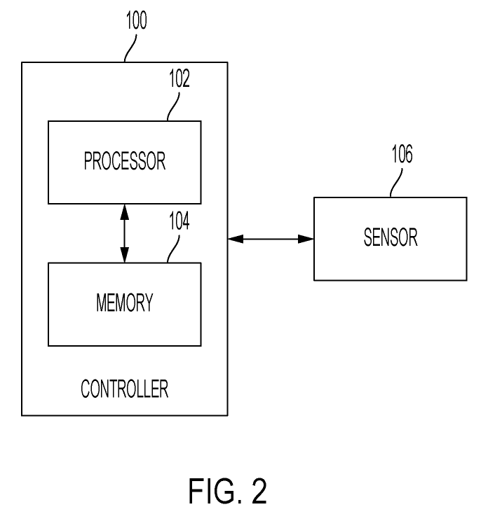

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

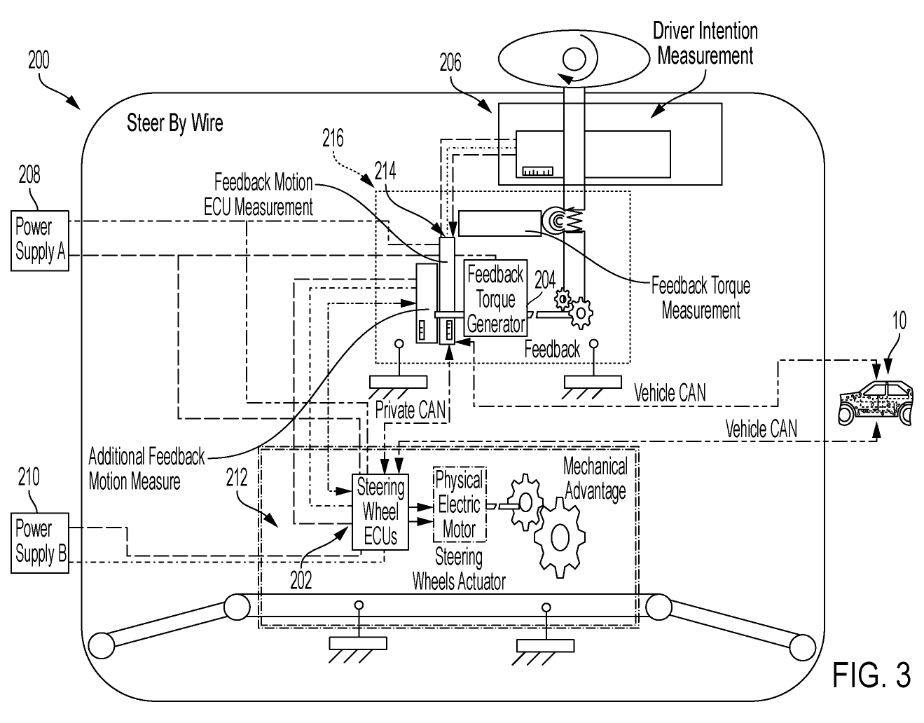

In some embodiments, the controller 100 may be configured to interact with and/or control various aspects of a SbW steering system. For example, FIG. 3 generally illustrates an architecture of an optimized SbW steering system 200 with limited feedback content, according to the principles of the present disclosure. The SbW steering system 200 may include a plurality of electronic control units (ECUs) 202. The ECUs 202 may include features similar to the controller 100. In some embodiments, the ECUs 202 may include an ECU1 202, and ECU2202, any/or any other suitable ECU 202. The controller 100 may control one or more aspects of the system 200. Additionally, or alternatively, one or more of the ECUs 202 and/or any ECU described herein, may be configured to control multiple channels (e.g., two or more electric motors, or other suitable control channels), and may comprise independent sub-ECUs configured to receive power from any suitable power source, independently (e.g., a first sub-ECU of an ECU may receive power from a power source that is different from a power source supplying power to a second sub-ECU of the ECU).

In some embodiments, in the system 200, if power supply A 208 fails, ECU2202, for example, may continue to provide interface and actuation to the wheels and may continue to receive data via a feedback torque generator 204 (e.g., which may be referred to herein as a feedback torque mechanism), which may indicate feedback motion, via power supply B 210.

In some embodiments, the controller 100 and/or the ECUs 202 may measure an intent of the driver of the vehicle 10 based on physical kinematics associated with the feedback, even if the feedback is no longer powered by power supply A 208 and no longer provides active feedback. Feedback is provided without power via passive methods such as, but not limited to, friction, stiffness, and damping and therefore active feedback is used or relied on.

In some embodiments, the controller 100 may determine whether one or more of the power supplies has failed. For example, the controller 100 may determine that the power supply A 208 has failed. The controller 100, in response to the determination that the power supply A 208 has failed, may control or instruct the ECU2202 of the steering actuator to actuate one or more wheels of the vehicle 10, based on steering input 206 (e.g., from the driver of the vehicle 10 and/or one or more autonomous control systems of the vehicle 10). The steering input 206 may be measured or detected by one or more sensors 106 or using any suitable technique or method. The ECU2202, while the power supply A 208 is determined to have failed, may determine, using a power supply other than the power supply A 208 (e.g., such as the power supply B 210), the steering input based on a measured feedback torque value determined by an ECU 214 of a feedback actuator 216 (e.g., using the physical kinematics of the feedback actuator 216).

In some embodiments, the controller 100 may determine that the power supply B 210 has failed. In response to the determination that the power supply B 210 has failed, the controller 100 may control or instruct the ECU 214 of the feedback actuator 216 to transmit diver intent to ECU1 202 of the steering wheels actuator 212 with or without the kinematics of the feedback actuator 216. Additionally, or alternatively, the steering wheels actuator 212 may provide interface to the steering wheel of the vehicle 10 and/or may provide motion to the road wheels using power supply A 208.

In the system 200, the steering wheels actuator 212 can actuator the wheels and is able to receive driver’s intent dependent on the feedback's physical kinematics using power supply B. Additionally, or alternatively, any other power supplies than B could be used except solely power supply A.

In some embodiments, the ECU2 202 of the steering wheels actuator 212 may receive the feedback motion via power supply B 210. Additionally, or alternatively, feedback motion could be receiver by a separate ECU (e.g., not part of the steering wheels actuator 212) that is powered by a separate power supply other than solely power supply A 208.

The steering wheels actuator 212 may receive the feedback motion via power supply B 210. Additionally, or alternatively, another ECU 202 (e.g., other than the ECU1202 and the ECU2202) of the steering wheels actuator 212 may receive the feedback motion while being powered by a separate power supply other than solely power supply A 208.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

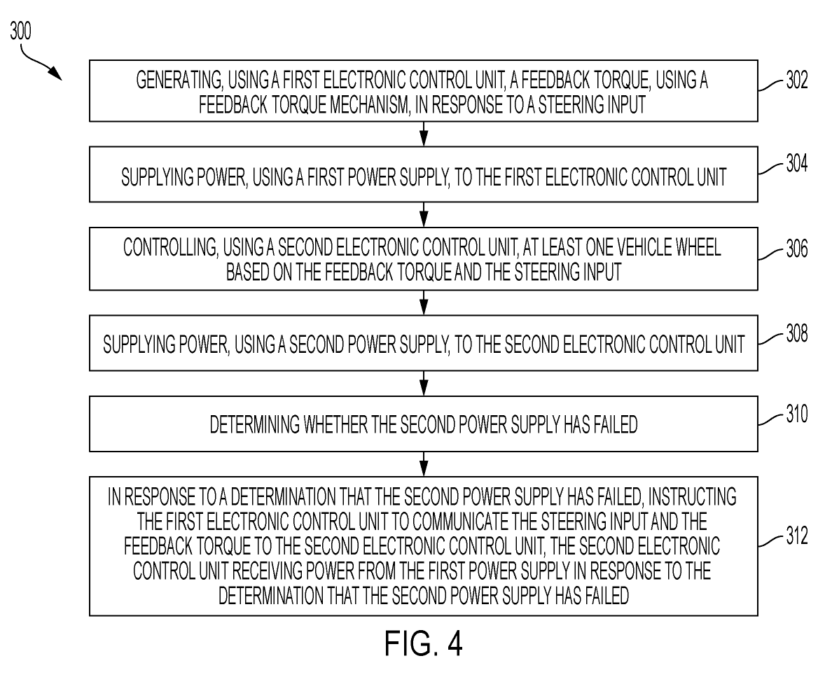

FIG. 4 generally illustrates a vehicle steering control method 300, according to the principles of the present disclosure. At 302, the method 300 generates, using a first electronic control unit, a feedback torque, using a feedback torque mechanism, in response to a steering input.

At 304, the method 300 supplies power, using a first power supply, to the first electronic control unit.

At 306, the method 300 controls, using a second electronic control unit, at least one vehicle wheel based on the feedback torque and the steering input.

At 308, the method 300 supplies power, using a second power supply, to the second electronic control unit.

At 310, the method 300 determines whether the second power supply has failed.

At 312, the method 300, in response to a determination that the second power supply has failed, instructs the first electronic control unit to communicate the steering input and the feedback torque to the second electronic control unit. The second electronic control unit receives power from the first power supply in response to the determination that the second power supply has failed.

In some embodiments, a steer-by-wire steering system includes: a physical mechanism for measurement of driver intention; and a feedback mechanism with an electronic control unit configured to: generate active feedback; measure feedback motion; and receive driver intention using a first power supply. The system also includes: an additional physical measurement of feedback motion that is physically dependent on kinematic aspects of feedback for an intention of a vehicle operator powered a second power supply; and a mechanism that interfaces and actuates road wheels and receives a measurement of feedback motion.

In some embodiments, a system for controlling vehicle steering includes: a first electronic control unit configured to generate a feedback torque, using a feedback torque mechanism, in response to a steering input; a first power supply configured to supply power to the first electronic control unit; a second electronic control unit configured to control at least one vehicle wheel based on the feedback torque and the steering input; a second power supply configured to supply power to the second electronic control unit; and a controller configured to: determine whether the second power supply has failed; and in response to a determination that the second power supply has failed, instruct the first electronic control unit to communicate the steering input and the feedback torque to the second electronic control unit, wherein the second electronic control unit receives power from the first power supply in response to the determination that the second power supply has failed.

In some embodiments, the first electronic control unit is associated with a feedback actuator. In some embodiments, the second electronic control unit is associated with a steering actuator. In some embodiments, the first power supply is independent from the second power supply. In some embodiments, the controller is further configured to determine whether the first power supply has failed. In some embodiments, the controller is further configured to, in response to a determination that the first power supply has failed, determine the steering input based on a steering input measurement generated by the first electronic control unit. In some embodiments, the controller is further configured to instruct the second electronic control unit to actuate the at least one vehicle wheel based on the steering input measurement.

In some embodiments, a method for controlling vehicle steering includes: generating, using a first electronic control unit, a feedback torque, using a feedback torque mechanism, in response to a steering input; supplying power, using a first power supply, to the first electronic control unit; controlling, using a second electronic control unit, at least one vehicle wheel based on the feedback torque and the steering input; supplying power, using a second power supply, to the second electronic control unit; determining whether the second power supply has failed; and in response to a determination that the second power supply has failed, instructing the first electronic control unit to communicate the steering input and the feedback torque to the second electronic control unit, wherein the second electronic control unit receives power from the first power supply in response to the determination that the second power supply has failed.

In some embodiments, the first electronic control unit is associated with a feedback actuator. In some embodiments, the second electronic control unit is associated with a steering actuator. In some embodiments, the first power supply is independent from the second power supply. In some embodiments, the method also includes determining whether the first power supply has failed. In some embodiments, the method also includes, in response to a determination that the first power supply has failed, determining the steering input based on a steering input measurement generated by the first electronic control unit. In some embodiments, the method also includes instructing the second electronic control unit to actuate the at least one vehicle wheel based on the steering input measurement.

In some embodiments, an apparatus for controlling vehicle steering includes a processor and a memory. The memory includes instructions that, when executed by the processor, cause the processor to: generate, using a first electronic control unit, a feedback torque, using a feedback torque mechanism, in response to a steering input; supply power, using a first power supply, to the first electronic control unit; control, using a second electronic control unit, at least one vehicle wheel based on the feedback torque and the steering input; supply power, using a second power supply, to the second electronic control unit; determine whether the second power supply has failed; and in response to a determination that one of the first power supply and the second power supply has failed, instruct the first electronic control unit to communicate the steering input and the feedback torque to the second electronic control unit, wherein the second electronic control unit receives power from the first power supply in response to the determination that the second power supply has failed.

In some embodiments, the first electronic control unit is associated with a feedback actuator. In some embodiments, the second electronic control unit is associated with a steering actuator. In some embodiments, the instructions further cause the processor to determine whether the first power supply has failed. In some embodiments, the instructions further cause the processor to, in response to a determination that the first power supply has failed, determine the steering input based on a steering input measurement generated by the first electronic control unit. In some embodiments, the instructions further cause the processor to instruct the second electronic control unit to actuate the at least one vehicle wheel based on the steering input measurement.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A system for controlling vehicle steering, the system comprising:
a first electronic control unit configured to generate a feedback torque, using a feedback torque mechanism, in response to a steering input;
a first power supply configured to supply power to the first electronic control unit;
a second electronic control unit configured to control at least one vehicle wheel using on the feedback torque mechanism and the steering input;
a second power supply configured to supply power to the second electronic control unit; and
a controller configured to:
determine whether the second power supply has failed; and
in response to a determination that the second power supply has failed, instruct the first electronic control unit to communicate the steering input and the feedback torque to the second electronic control unit, wherein the second electronic control unit receives power from the first power supply in response to the determination that the second power supply has failed.

2. The system of claim 1, wherein the first electronic control unit is associated with a feedback actuator.

3. The system of claim 1, wherein the second electronic control unit is associated with a steering actuator.

4. The system of claim 1, wherein the first power supply is independent from the second power supply.

5. The system of claim 1, wherein the controller is further configured to determine whether the first power supply has failed.

6. The system of claim 5, wherein the controller is further configured to, in response to a determination that the first power supply has failed, determine the steering input based on a steering input measurement generated by the first electronic control unit.

77 The system of claim 6, wherein the controller is further configure to instruct the second electronic control unit to actuate the at least one vehicle wheel based on the steering input measurement.

8. A method for controlling vehicle steering, the method comprising:
generating, using a first electronic control unit, a feedback torque, using a feedback torque mechanism, in response to a steering input;
supplying power, using a first power supply, to the first electronic control unit;
controlling, using a second electronic control unit, at least one vehicle wheel based on the feedback torque and the steering input;
supplying power, using a second power supply, to the second electronic control unit;
determining whether the second power supply has failed; and
in response to a determination that the second power supply has failed, instructing the first electronic control unit to communicate the steering input and the feedback torque to the second electronic control unit, wherein the second electronic control unit receives power from the first power supply in response to the determination that the second power supply has failed.

9. The method of claim 8, wherein the first electronic control unit is associated with a feedback actuator.

10. The method of claim 8, wherein the second electronic control unit is associated with a steering actuator.

11. The method of claim 8, wherein the first power supply is independent from the second power supply.

12. The method of claim 8, further comprising determining whether the first power supply has failed.

13. The method of claim 12, further comprising, in response to a determination that the first power supply has failed, determining the steering input based on a steering input measurement generated by the first electronic control unit.

1414 The method of claim 13, further comprising instructing the second electronic control unit to actuate the at least one vehicle wheel based on the steering input measurement.

15. An apparatus for controlling vehicle steering, the apparatus comprising:
a processor; and
a memory including instructions that, when executed by the processor, cause the processor to:
generate, using a first electronic control unit, a feedback torque, using a feedback torque mechanism, in response to a steering input;
supply power, using a first power supply, to the first electronic control unit;
control, using a second electronic control unit, at least one vehicle wheel based on the feedback torque and the steering input;
supply power, using a second power supply, to the second electronic control unit;
determine whether the second power supply has failed; and
in response to a determination that one of the first power supply and the second power supply has failed, instruct the first electronic control unit to communicate the steering input and the feedback torque to the second electronic control unit, wherein the second electronic control unit receives power from the first power supply in response to the determination that the second power supply has failed.

16. The apparatus of claim 15, wherein the first electronic control unit is associated with a feedback actuator.

17. The apparatus of claim 15, wherein the second electronic control unit is associated with a steering actuator.

18. The apparatus of claim 15, wherein the instructions further cause the processor to determine whether the first power supply has failed.

19. The apparatus of claim 18, wherein the instructions further cause the processor to, in response to a determination that the first power supply has failed, determine the steering input based on a steering input measurement generated by the first electronic control unit.

20. The apparatus of claim 19, wherein the instructions further cause the processor to instruct the second electronic control unit to actuate the at least one vehicle wheel based on the steering input measurement.
